(19) United States
(12) Patent Application Publication
(10) Pub. No.: US 2025/0232196 A1
(43) Pub. Date: Jul. 17, 2025

(54) SYSTEM AND METHOD FOR REQUIREMENTS RECOGNITION FOR SYSTEM-ON-A-CHIP VERIFICATION

(71) Applicant: SK hynix Inc., Gyeonggi-do (KR)

(72) Inventor: Siarhei ZALIVAKA, Gdansk (PL)

(21) Appl. No.: 18/618,655

(22) Filed: Mar. 27, 2024

Related U.S. Application Data
(60) Provisional application No. 63/621,889, filed on Jan. 17, 2024.

(51) Int. Cl. G06N 5/046; G06F 40/205; G06V 30/42

(52) U.S. Cl. CPC G06N 5/046; G06F 40/205; G06V 30/42

(57) ABSTRACT

A system for analyzing documents to be used for verifying a system-on-a-chip (SoC). The system includes: a parser configured to analyze a technical document associated with the SoC to generate multiple text fragments; a data preparator configured to convert the multiple text fragments into a dataset for a machine learning model; and a machine learning model block configured to perform a training mode including multiple training epochs or an inference mode. In each training epoch, the machine learning model block trains the machine learning model based on the dataset such that a label is appended to each text fragment. In the inference mode, the machine learning model block makes a prediction for each text fragment based on the training result to generate the dataset with prediction values.

### CROSS-REFERENCE TO RELATED APPLICATION(S)

This application claims the benefit of U.S. Provisional Application No. 63/621,889, filed on Jan. 17, 2024, the entire contents of which are incorporated herein by reference.

### BACKGROUND

### 1. Field

Embodiments of the present disclosure relate to design and verification of a system-on-a-chip (SoC).

### 2. Description of the Related Art

Nowadays, modern SoC becomes more sophisticated due to high complexity of its design. As a result, a typical SoC design includes a large number of external reusable intellectual property (IP) cores (i.e., a reusable unit of logic or integrated circuit layout design), which drastically reduce a design time. On the other hand, a verification process may take more than half of the total design time. Therefore, in order to reduce a verification time, engineers may utilize verification IP (VIP).

Storage devices such as NAND flash memory devices include many complicated IP components (e.g., Embedded MultiMedia Card (eMMC), Open NAND Flash Interface (ONFi), Universal Flash Storage (UFS), a low-power Mobile Industry Processor Interface (MIPI) Physical Layer (M-PHY), Non-Volatile Memory express (NVMe), etc.) and some of them are frequently updated. Thus, VIP design process consumes a significant amount of time and manpower resources. A verification process checks whether the designed system meets requirements described in the design specification for the system (hereinafter “specification” or “specifications”). Thus, any verification process requires a thorough understanding of the specification. It is in this context that embodiments of the invention arise.

### SUMMARY

Aspects of the present invention include a system and a method for analyzing technical documents to be used for verifying a system-on-a-chip (SoC).

In one aspect of the present invention, a system for analyzing documents to be used for verifying a system-on-a-chip (SoC) includes: a parser configured to analyze a technical document associated with the SoC to generate multiple text fragments; a data preparator configured to convert the multiple text fragments into a dataset suitable for a machine learning model; a machine learning model block configured to receive the dataset and perform a training mode including multiple training epochs or an inference mode; and a documents processor. The technical document includes at least one of a labeled document for the training mode and an unlabeled document for the inference mode. The machine learning model block is configured to: in each training epoch of the training mode, train the machine learning model based on the dataset such that a label is appended to each text fragment, and in the inference mode, make a prediction for each text fragment of the dataset based on the training result of the machine learning model to generate the dataset with prediction values. The documents processor is configured to receive the unlabeled document and the dataset with the prediction values, and convert the source unlabeled document based on the dataset with the prediction values into a source labeled document used for verifying the SoC.

In one aspect of the present invention, a method for analyzing documents to be used for verifying a system-on-a-chip (SoC) includes: analyzing, by a parser, a technical document associated with the SoC to generate multiple text fragments; converting, by a data preparator, the multiple text fragments into a dataset suitable for a particular machine learning model; and receiving, by a machine learning model block, the dataset and performing a training mode including multiple training epochs or an inference mode. The technical document includes one of a labeled document for the training mode and an unlabeled document for the inference mode. Each training epoch of the training mode includes training the machine learning model based on the dataset such that a label is appended to each text fragment. The inference mode includes making a prediction for each text fragment of the dataset based on the training result of the machine learning model to generate the dataset with prediction values. The method further includes receiving, by a documents processor, the unlabeled document and the dataset with the prediction values, and converting the source unlabeled document based on the dataset with the prediction values into a source labeled document used for verifying the SoC.

Additional aspects of the present invention will become apparent from the following description.

### BRIEF DESCRIPTION OF THE DRAWINGS

FIG. 1 is a diagram illustrating a documents analysis system and a system-on-a-chip (SoC) verification system in accordance with one embodiment of the present invention

FIG. 2 is a diagram illustrating a documents analysis system in accordance with one embodiment of the present invention.

FIG. 3 illustrates a confusion matrix for an M-PHY specification based dataset in accordance with one embodiment of the present invention.

FIG. 4 illustrates a confusion matrix for a PURE dataset (PUblic REquirements dataset), in accordance with one embodiment of the present invention.

FIG. 5 illustrates a small part of the PCIe v.5 specification and a question in accordance with one embodiment of the present invention.

FIG. 6 illustrates an artificial intelligence model Generative Pre-trained Transformer (GPT) 3.5 model response in accordance with one embodiment of the present invention.

FIG. 7 illustrates the results of the model on PCIe specification PDF file in accordance with one embodiment of the present invention.

FIG. 8 is a flowchart illustrating a documents analysis method in accordance with one embodiment of the present invention.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of the embodiments of the present invention is provided below along with accompanying figures that illustrate aspects of the present invention. The present invention is described in connection with such embodiments, but the present invention is not limited to any embodiment. The present invention encompasses numerous alternatives, modifications and equivalents. Numerous specific details are set forth in the following description in order to provide a thorough understanding of the present invention. These details are provided for the purpose of example; the present invention may be practiced without some or all of these specific details. For clarity, technical material that is known in technical fields related to the present invention may not have been described in detail.

Engineers typically decompose the specification into a set of requirements, which are used to develop test benches, stimulus sequences, functional models, checkers, coverage model, etc. Existing specifications for a widely used IPs (e.g., peripheral component interconnect express (PCIe) which is a type of connection used for high-speed data transfer between electronic components) may have an extraordinary volume, i.e., thousands of pages. This makes manual processing of frequently changing specifications a task requiring a large amount of time (days or months) even for a technical expert in this field. Thus, large language models (LLM) can partially automate this manual process and, as a result, can reduce the amount of time required for manual specification analysis.

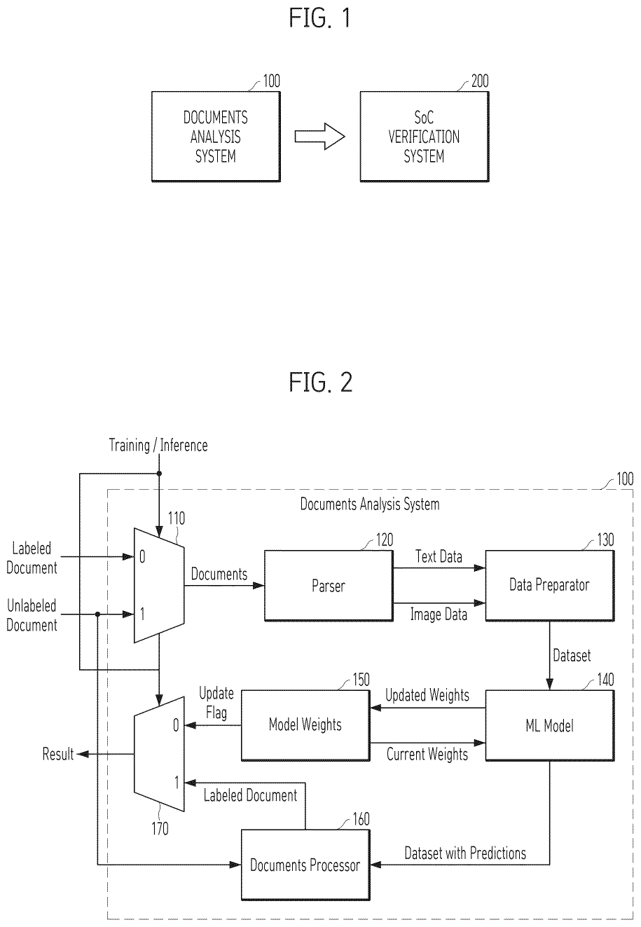

FIG. 1 is a diagram illustrating a documents analysis system 100 and a system-on-a-chip (SoC) verification system 200 in accordance with one embodiment of the present invention.

Referring to FIG. 1, the SoC verification system 200 may perform a verification process on a designed system (i.e., SoC). In some embodiments, the designed system may be IP components of storage devices such as NAND flash memory devices, e.g., Embedded MultiMedia Card (eMMC), Open NAND Flash Interface (ONFi), Universal Flash Storage (UFS), a low-power Mobile Industry Processor Interface (MIPI) Physical Layer (M-PHY), Non-Volatile Memory express (NVMe), etc. The SoC verification system 200 may verify whether the designed system meets requirements described in a technical document for the designed system. In some embodiments, the technical document may include at least one of a specification, a manual, a user guide and a standard.

The documents analysis system 100 may analyze the technical document to be used for verifying the designed system, and provide the SoC verification system 200 with the analysis result. The analysis results obtained from the system 100 may be also used as an input by verification engineers in order to design the verification system 200.

FIG. 2 is a diagram illustrating the documents analysis system 100 in accordance with one embodiment of the present invention.

Referring to FIG. 2, the documents analysis system 100 may include a parser 120, a data preparator 130, a machine learning (ML) model block 140, a storage 150 and a documents processor 160. Further, the documents analysis system 100 may include a first multiplexer 110 and a second multiplexer 170.

The documents analysis system 100 takes a technical document as an input and executes required processing to prepare a dataset for the pre-trained or not trained machine learning (ML) model 140. The documents analysis system 100 may work either in a training mode in order to improve the quality of the ML model based on new input document, or in an inference mode in order to make a prediction for the given technical document parsed into a dataset suitable for the ML model.

The first multiplexer 110 may output, as an input document of the documents analysis system 100, a labeled document in the training mode, and an unlabeled document in the inference mode.

In the training mode, the input document should be labeled, i.e., texts within the document are appended with labels. Text data extracted from the document may be divided into multiple text fragments (e.g., sentence, paragraph, page or any other reasonable amount of text). Each text fragment may be automatically or manually classified and labeled as a requirement or non-requirement. Requirement means that each text fragment meets a required characteristic described in the document. Non-requirement means that each text fragment does not meet a required characteristic described in the document. The training mode may be a supervised learning technique, more precisely, binary classification. The difference between the classification of the training mode and general binary classification algorithm is the application domain, i.e., source data (i.e., the specification text) is used for verification IP (VIP) development process (i.e., a verification of the designed system), and classes describe the text as a requirement (1) or non-requirement (0). However, this classification method is not limited to these two particular classes and may be extended for a larger number of classes. In some embodiments, the labels can be two binary values: a first binary value (0) which represents that the piece of text does not have a required characteristic, and a second binary value (1) which represents that the piece of text has a required characteristic. Alternatively, the labels can be a probability value having the value in a range from 0 to 1, which represents the likelihood of the text having the required characteristic. For example, the higher probability value means the higher likelihood.

In the inference mode, the input document has no labels in order to allow the documents analysis system 100 to make a prediction whether the parts of the text within the document have required characteristic or not. The documents analysis system 100 in the inference mode can also output a class label (0 or 1) or a probability value for each part of the document as a prediction. The text data with the prediction result may be processed to provide a source document with a markup for further usage in computer system development (e.g., the SoC verification system 200), or for an additional check by an engineer.

The documents analysis system 100 may improve the requirement extraction process leading to saving time for the initial stage of the VIP development. Comparing to the manual requirement extraction process performed by an engineer, various embodiments of the present invention automate the extraction process which consumes less manpower.

The parser 120 may receive the input document from the first multiplexer 110, analyze the content of the input document (with or without labels), and convert the input document into multiple text fragments with or without labels. In some embodiments, the multiple text fragments may be a list of text fragments including sentences, paragraphs, pages, etc. Since the document often contains one or figures, the parser 120 may extract image data from the figures, convert the extracted image data to the meaningful text data with or without labels and/or analyze the contents of the image data.

The data preparator 130 may receive the multiple text fragments from the parser 120, and convert the multiple text fragments into a dataset suitable for a particular machine learning model used in the ML model block 140. In some embodiments, the data preparator 130 may connect text data (i.e., text fragments) with corresponding labels provided by the parser 120 to generate the dataset. If the system operates in the inference mode, the data preparator 130 converts text data to the dataset with the format expected by the ML model block 140.

In some embodiments, there may be two ways of forming the dataset. The first way is the use of publicly available but less specific datasets (e.g., PURE dataset). The advantage of this approach is a relative simplicity of the data collection process, and the disadvantage is a lower quality of the data, which can be less appropriate for a specific task (e.g., requirements recognition for the VIP design). The second way is by manual labeling. In this approach, the quality of the data is better compared to the public datasets (such as PURE), but the labeling process often involves significant manpower resources, i.e., hours or days of a qualified engineer's work.

The ML model block 140 may receive the dataset from the data preparator 130 and perform a training process in a training mode or an inference process in an inference mode. In some embodiments, the training process may include multiple training epochs. The ML model block 140 may load model weights from the storage 150.

In the training mode (i.e., in each training epoch of the training mode), the ML model block 140 may train the ML model to execute a training process based on the dataset provided by the data preparator 130. As a result, model weights would be updated within the optimization process in order to improve the quality of the ML model, which is determined by the performance metric (accuracy, precision, recall, etc.). The updated weights may be stored internally (i.e., in the storage 150) after the training process is over. In some embodiments, the ML model may include large language models (LLM).

In the inference mode, the ML model block 140 may make a prediction for each text fragment provided by the data preparator 130. In some embodiments, the result of the prediction may be a binary value (e.g., zero (0) for a piece of text not having a required characteristic, and one (1) for a piece of text having a required characteristic). Alternatively, the result of the prediction may be a probability value (a value in a range from zero (0) to one (1)).

The ML model may be trained using the dataset. In some embodiments, the structure of the dataset may have input and output parameters, i.e., a single input parameter as the text data, which is going to be classified, and a single target parameter as a class value (0 or 1). The text data can be represented with a different granularity level (e.g., sentence, paragraph or larger piece of text). Since the requirement can be formed in different forms (such as many sentences, paragraphs or even pages), the choice of the granularity level depends on the developer. For example, if the text is divided into sentences, multiple sentences can be labeled as different requirements, or as one requirement described by larger amount of text. On the other hand, labeling larger pieces of text as one requirement may involve additional computational resources and a higher level of expertise from the person who labels the data.

When the dataset is ready and has sufficient number of records (e.g., at least few a hundred) of various data (different examples of requirements and non-requirements), the dataset can be used to train the ML model. In various embodiments of the present invention, the model would be fine-tuned as full training can be both inefficient and require a significant amount of computational resources. In some embodiments, the training process requires implementation of the ML model in software (e.g., using the Python programming language and its libraries) and hardware for executing machine learning training algorithm (e.g., graphics processing unit (GPU)). The collected dataset may be fed to the model in order to improve training metric (e.g., accuracy, recall, precision. etc.) during multiple training epochs, i.e., processing the whole dataset multiple times in order to classify the text as requirement or non-requirement with better performance. The training process may be usually implemented as an optimization algorithm (e.g., gradient descent, momentum, Adam, etc.). The quality of the trained model highly depends on an amount and diversity of the training dataset.

The trained model can work in the inference mode, i.e., the trained model returns a label 0 (non-requirement) or 1 (requirement) for unknown piece of text (i.e., text fragment) given as an input. The model also may return a probability of being a requirement, i.e. a number in the range from 0 to 1. Here, the bigger probability value means a higher likelihood of the piece of text being a requirement. For example, if the model returns a value of 0.25, the piece of text can be classified as a non-requirement. If the model returns a value of 0.83, the piece of text can be classified as a requirement. The final decision may be made by a developer based on the probability provided by the ML model block 140. Since the trained model can show different performance, the final usage scenario can be fully automatic or semi-automatic. In the first scenario, the ML model can classify any piece of text within the document as a requirement or non-requirement correctly (or with a negligible error). In the second scenario, the ML model gives the probability of being a requirement for a given piece of text and the output of the ML model should be analyzed by an engineer to make a final decision.

The ML model block 140 may provide to the documents processor 160 the dataset with prediction results. Here, the text fragments in the dataset may have a corresponding prediction result. The documents processor 160 may receive source unlabeled document and the dataset with prediction results. The documents processor 160 may convert the source unlabeled document into a labeled document, based on source text data from the source unlabeled document, and the prediction results. The labeled document may be provided to the second multiplexer 170.

The documents analysis system 100 may provide two types of outputs through the second multiplexer 170. That is, in the training mode, the second multiplexer 170 may output a flag as an acknowledgement that the model weights of the storage 150 are updated or not. For example, the flag may have a first value (i.e., one (1)) that the model weights of the storage 150 were updated, or a second value (i.e., zero (0)) that the model weights of the storage 150 were not updated. In the inference mode, the second selector 170 may output the labeled document, which is received from the documents processor 160.

### EXAMPLE

The documents analysis system 100 has been experimentally verified using a dataset, which is manually formed from the M-PHY 4.1 specification (a specification for a physical layer interface designed for mobile multimedia devices) and Generative Pretrained Transformer 2 (GPT-2) model (an AI model). The GPT-2 model was also trained on the PURE dataset in order to compare performance based on the quality of the provided data. The trained model was tested on the PCIe v.5 specification and showed positive results.

The M-PHY 4.1 specification was analyzed in order to make the verification IP (VIP). Therefore, its content was transformed into a dataset containing 1254 fragments of text (text fragments), which include 332 requirements and 922 non-requirements. Since the specification has been analyzed manually, the text data is split into different text fragments, i.e., some of the fragments are sentences, some of the fragments are paragraphs, some of the fragments have an arbitrary size. The PURE dataset has a larger size, i.e., 7745 text fragments, which include 4145 requirements and 3600 non-requirements. However, this dataset is less specific to the hardware requirements extracted from specifications and has more generic software development requirements.

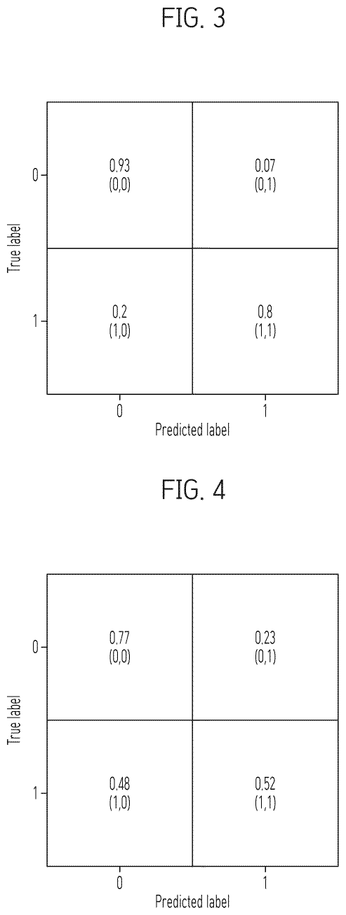

The GPT-2 model was implemented using Hugging Face library as a 24-layer GPT-2 model. This GPT-2 model was trained on the M-PHY specification based dataset, and tested on the same specification but parsed into sentences. The confusion matrix demonstrating the result of this experiment is shown in FIG. 3. Herein, the confusion matrix is a table that is used in classification problems to assess where errors in the model were made. The rows represent the actual classes the outcomes should have been, while the columns represent the predicted classes provided by the model. The cells are showing the correspondence of the predicted classes to the actual classes. Using this table, it is easy to see which predictions are wrong.

Referring to FIG. 3, the confusion matrix shows the percentage (or actual number) of correct and incorrect classifications for all classes. For the binary classification, the (0, 0) cell shows the percentage of correct classifications for the class 0, the (0, 1) cell shows the percentage of incorrect classifications for the class 0, the (1, 0) cell shows the percentage of incorrect classifications for the class 1, and the (1, 1) cell shows the percentage of correct classifications for the class 1. In FIG. 3, the (0, 0) cell represents the intersection of (true label=0, predicted label=0), the (0, 1) cell represents the intersection of (true label=0, predicted label=1), the (1, 0) cell represents the intersection of (true label=1, predicted label=0), and the (1, 1) cell represents the intersection of (true label=1, predicted label=1).

The same experiment has been performed on the PURE dataset, and tested on the same M-PHY specification parsed into sentences. The results are shown in FIG. 4.

Comparing the results of FIGS. 3 and 4, the performance of the model on the PURE dataset is worse than that on M-PHY specification based dataset. This can be explained by a higher degree of specificity of this dataset as compared to the more general PURE dataset.

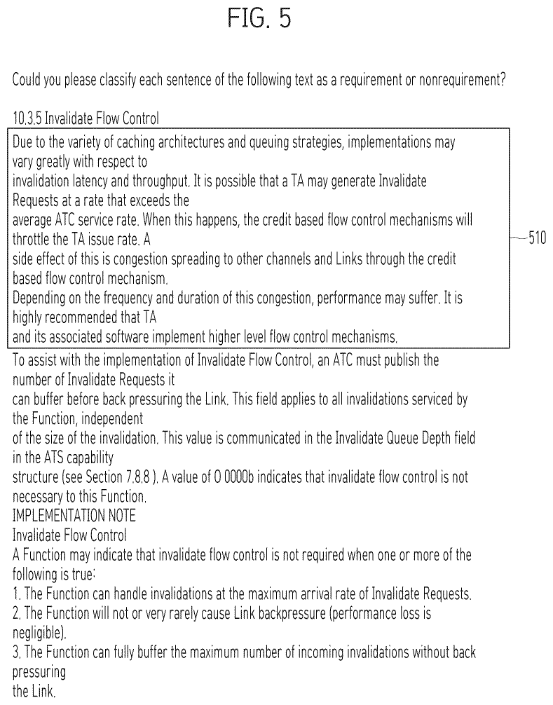

The model has been also compared to the GPT 3.5 model, openly available as an application programming interface (API) and a web application. The text (i.e., a small excerpt from the PCIe-v.5 specification) shown in FIG. 5 has been processed in order to extract requirements using both the model of the present invention and the GPT 3.5 model (ChatGPT implementation). For the requirements extraction, the prompt “Could you please classify each sentence of the following text as a requirement or nonrequirement?” as shown in FIG. 5 may be entered through the API or web application.

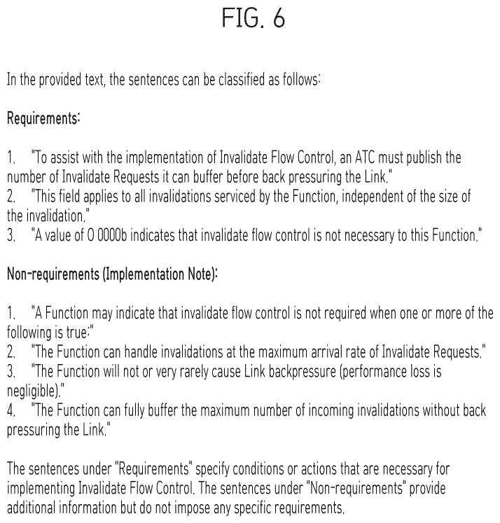

The GPT 3.5 model has generated an output shown in FIG. 6.

Referring to FIG. 6, the GPT 3.5 ignored the sentences between “Due to the variety . . . ” and “To assist with . . . ” (FIG. 5, 510) and did not mark the sentences as “non-requirements.” Also, the non-requirements 2, 3, 4 can be considered as requirements, which have been detected by the model of the present invention. As a result, the smaller model (i.e., GPT-2 in the technique of the present invention) completed this task better than the larger model (GPT 3.5). Since the model of the present invention has been fine-tuned on the specific data related to the specifications, the model of the present invention shows better performance comparing to the LLM trained on general text data.

The technique of the present invention has been also implemented within the automated documents analysis system 100 of FIG. 2 as a software using Python programming language. In this implementation, the parser 120 and the documents processor 160 may be based on the PyPDF2 library which is capable of splitting, merging, cropping, and transforming the pages of PDF files. The data preparator 130 may convert extracted text data into the data frames (e.g., Pandas, a Python library used for working with data sets). The ML model block 140 may be implemented using the Hugging Face library. The parser 120 may also include an image-to-text converter based on visual attention.

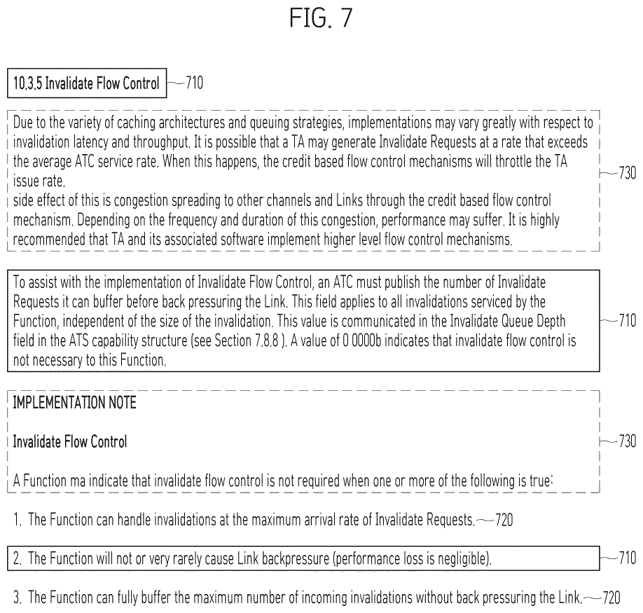

Within the implemented automatic system 100, the above-mentioned trained GPT-2 model has been also tested in the inference mode on the PDF document, which is a PCIe v.5 specification. The document has been parsed into the text fragments, which have been classified by the trained model, and converted into the labeled document. The text fragments have been classified in the PDF document based on the probability value. One page of the resulting document is shown in FIG. 7. In the illustrated example of FIG. 7, 710 corresponds to text fragments of which the probability is higher than 0.6, 720 corresponds to text fragments of which the probability is between 0.2 and 0.6, 730 corresponds to text fragments of which the probability is lower than 0.2. In the example above, the principle is to divide the range from 0 to 1 into three parts, i.e. non-requirement (low values), uncertainty (medium values), requirement (high values). In this case, it is more important not to miss the requirements even if there is a mistake, i.e., non-requirement classified as requirement or uncertainty is better than missing the real requirement. Thus, the low values range is smaller ([0.0, 0.2]) than the others ([0.2, 0.6] and [0.6, 1.0]). In general, these three parts can be tuned by the engineer using this system.

5% of the randomly chosen text fragments within the specification have been manually verified. The model developed and demonstrate here has shown less than 10% errors, which shows that the manual requirements analysis process can be automated and valuable time of engineers can be significantly saved.

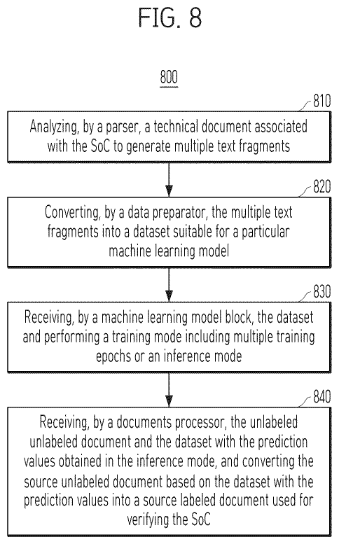

FIG. 8 is a flowchart illustrating a documents analysis method 800 in accordance with one embodiment of the present invention. The method 800 may be performed by the documents analysis system 100 for analyzing documents to be used for verifying a system-on-a-chip (SoC).

Referring to FIG. 8, at operation 810, the method 800 may analyzing, by a parser, a technical document associated with the SoC to generate multiple text fragments.

Operation 820 may include converting, by a data preparator, the multiple text fragments into a dataset suitable for a particular machine learning model.

Operation 830 may include, receiving, by a machine learning model block, the dataset and performing a training mode including multiple training epochs or an inference mode.

In some embodiments, the technical document includes one of a labeled document for the training mode and an unlabeled document for the inference mode.

In some embodiments, the machine learning model block is configured to: in each training epoch of the training mode, train the machine learning model based on the dataset such that a label is appended to each text fragment. The label may indicate whether each text fragment has a required characteristic for the SoC. In the inference mode, the machine learning model block is configured to make a prediction for each text fragment of the dataset based on the training result of the machine learning model to generate the dataset with prediction values.

Operation 840 may include, receiving, by a documents processor, the unlabeled document and the dataset with the prediction values obtained in the inference mode, and converting the source unlabeled document based on the dataset with the prediction values into a source labeled document used for verifying the SoC.

In some embodiments, the technical document may include one of a specification, a manual, a user guide and a standard, which are associated with the SoC.

In some embodiments, each text fragment may include text data for at least one of a sentence, a paragraph, and a page.

In some embodiments, when the technical document includes image, the parser is configured to extract the image and convert the image into meaningful text data.

In some embodiments, the data preparator is configured to connect text data with a label among the multiple text fragments to generate the dataset.

In some embodiments, the machine learning model block may execute each training epoch based on the dataset to update one or more model weights associated with particular performance metrics of the machine learning model.

In some embodiments, the machine learning model block may generate an acknowledgement signal indicating that the model weights are updated.

In some embodiments, the label may include one of a binary value and a probability value.

In some embodiments, the binary value may include one of a first binary value indicating that each text fragment does not have the required characteristic, and a second binary value indicating that each text fragment has the required characteristic.

In some embodiments, the probability value may indicate the extent of which each text fragment has the required characteristic.

As described above, embodiments of the present invention provide a scheme for analyzing technical documents to be used for verifying a system-on-a-chip (SoC). This scheme can save the manpower required for VIP development significantly by automation the requirements analysis process. This scheme can enhance the verification process of storage devices such as NAND flash memory devices.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives. Furthermore, the embodiments may be combined to form additional embodiments.

What is claimed is:

1. A system for analyzing documents to be used for verifying a system-on-a-chip (SoC), the system comprising:
a parser configured to analyze a technical document associated with the SoC to generate multiple text fragments;
a data preparator configured to convert the multiple text fragments into a dataset suitable for a machine learning model;
a machine learning model block configured to receive the dataset and perform a training mode including multiple training epochs or an inference mode; and
a documents processor,
wherein the technical document includes at least one of a labeled document for the training mode and an unlabeled document for the inference mode,
wherein the machine learning model block is configured to:
in each training epoch of the training mode, train the machine learning model based on the dataset such that a label is appended to each text fragment, and
in the inference mode, make a prediction for each text fragment of the dataset based on the training result of the machine learning model to generate the dataset with prediction values, and
wherein the documents processor is configured to receive the unlabeled document and the dataset with the prediction values, and convert the source unlabeled document based on the dataset with the prediction values into a source labeled document used for verifying the SoC.

2. The system of claim 1, wherein the technical document includes at least one of a specification, a manual, a user guide and a standard, which are each associated with the SoC.

3. The system of claim 1, wherein each text fragment includes text data for at least one of a sentence, a paragraph, and a page.

4. The system of claim 3, wherein, when the technical document includes image, the parser is configured to extract the image and convert the image into meaningful text data.

5. The system of claim 1, wherein the data preparator is configured to connect text data with a label among the multiple text fragments to generate the dataset.

6. The system of claim 1, wherein the machine learning model block is configured to execute each training epoch based on the dataset and update one or more model weights associated with particular performance metrics of the machine learning model.

7. The system of claim 6, wherein the machine learning model block is configured to generate an acknowledgement signal indicating that the model weights are updated.

8. The system of claim 1, wherein the label includes at least one of a binary value and a probability value.

9. The system of claim 8, wherein the binary value includes one of a first binary value indicating that each text fragment does not have the required characteristic, and a second binary value indicating that each text fragment has the required characteristic.

10. The system of claim 8, wherein the probability value indicates the extent of which each text fragment has the required characteristic.

11. A method for analyzing documents to be used for verifying a system-on-a-chip (SoC), the method comprising:
analyzing, by a parser, a technical document associated with the SoC to generate multiple text fragments;
converting, by a data preparator, the multiple text fragments into a dataset suitable for a machine learning model;
receiving, by a machine learning model block, the dataset and performing a training mode including multiple training epochs or an inference mode, wherein the technical document includes at least one of a labeled document for the training mode and an unlabeled document for the inference mode, wherein each training epoch of the training mode includes training the machine learning model based on the dataset such that a label is appended to each text fragment, and wherein the inference mode includes making a prediction for each text fragment of the dataset based on the training result of the machine learning model to generate the dataset with prediction values; and
receiving, by a documents processor, the unlabeled document and the dataset with the prediction values, and converting the source unlabeled document based on the dataset with the prediction values into a source labeled document used for verifying the SoC.

12. The method of claim 11, wherein the technical document includes at least one of a specification, a manual, a user guide and a standard, which are each associated with the SoC.

13. The method of claim 11, wherein each text fragment includes text data for at least one of a sentence, a paragraph, and a page.

14. The method of claim 13, wherein the analyzing of the technical document includes extracting, when the technical document includes image, the image and convert the image into meaningful text data.

15. The method of claim 11, wherein the converting of the multiple text fragments includes connecting text data with a label among the multiple text fragments to generate the dataset.

16. The method of claim 11, wherein each training epoch is executed based on the dataset and updates one or more model weights associated with particular performance metrics of the machine learning model.

17. The method of claim 16, further comprising: generating, by the machine learning model block, an acknowledgement signal indicating that the model weights are updated.

18. The method of claim 11, wherein the label includes at least one of a binary value and a probability value.

19. The method of claim 18, wherein the binary value includes one of a first binary value indicating that each text fragment does not have the required characteristic, and a second binary value indicating that each text fragment has the required characteristic.

20. The method of claim 18, wherein the probability value indicates the extent of which each text fragment has the required characteristic.
